(19) United States
(12) Patent Application Publication
(10) Pub. No.: US 2009/0202730 A1
(43) Pub. Date: Aug. 13, 2009

(54) APPLICATION APPARATUS, APPLICATION METHOD AND METHOD OF THE MANUFACTURING OF COATED MATERIAL

(75) Inventors: Takumi Yamaoka, Chino-shi (JP); Mutsuhiko Ota, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/361,232

(22) Filed: Jan. 28, 2009

(30) Foreign Application Priority Data
Jan. 28, 2008 (JP) 2008-016743

(51) Int. Cl. B05D 1/30; B05C 11/00

(52) U.S. Cl. 427/420; 118/668

(57) ABSTRACT

A slit coating type application apparatus includes a holding table 20 which holds a substrate 1 on a vertically lower surface, a first liquid tank 30 which is disposed so as to face the surface of the substrate 1 held on the holding table 20 and stores a predetermined coating liquid 2, a coating head 40 which is held so as to be vertically moved in the first liquid tank 30 and has a slit-shaped nozzle 41 for flowing the coating liquid stored in the first liquid tank 30 toward the surface of the substrate 1, a second liquid tank 50 which is supported so as to be vertically moved, communicates with the first liquid tank 30 through a communicating pipe 60, and stores the coating liquid 2, and a height control unit which controls the height of the second liquid tank 50 according to the movement of the coating head 40 when the coating liquid 2 is coated on the substrate 1.

### BACKGROUND OF THE INVENTION

The entire disclosure of Japanese Patent Application No. 2008-0167, filed Jan. 28, 2008 is incorporated by reference herein.

1. Field of the Invention

The present invention relates to a slit coating type application apparatus for flowing a predetermined coating liquid from the front end of a nozzle and forming a coated film on a surface of a substrate, an application method using the slit coating type application apparatus, and a method of manufacturing a coated material using the slit coating type application apparatus.

2. Invention of Related Art

As an application apparatus for coating a substrate such as a semiconductor wafer or a glass substrate with a predetermined coating liquid (solvent) such as a resist material, an insulating material or the like, for example, there is an apparatus for flowing a coating liquid from the front ends of a nozzle of a coating head by a capillary phenomenon and coating a surface of a substrate with the coating liquid. In detail, for example, like Japanese Unexamined Patent Application Publication No. 2003-164795, there is an apparatus for flowing a coating liquid from front ends of a base nozzle by a capillary phenomenon and coating a surface of a coated material with the coating liquid by arranging the base nozzle in a storage container in which the coating liquid is contained.

In such an application apparatus, the coating head having a nozzle (base nozzle) needs to be vertically moved when the coating liquid is coated on the substrate, but the liquid level of the coating liquid in the liquid tank (storage container) moves upward or downward by the movement of such a coating head and thus a pressure variation occurs. The outflow amount of the coating liquid from the nozzle varies by the pressure variation and thus a coating film cannot be formed on the surface of the substrate by a uniform thickness. For example, when the coating head moves downward, the liquid level of the coating liquid in the liquid tank moves upward, the outflow amount of the coating liquid is temporarily increased by the pressure variation, and thus the thickness of the coating film formed on the substrate is partially increased. In addition, for example, bubbles may be entrained when the outflow amount of the coating liquid is increased and thus pinholes may be formed in the coating film.

Such a problem can be prevented by providing, for example, a sack back valve, pump or the like and properly controlling the liquid level height (amount) of the coating liquid in the liquid tank. However, the apparatus becomes complicated and cost is significantly increased.

### SUMMARY OF THE INVENTION

The invention is contrived to solve the above-described problems. An object of the invention is to provide a slit coating type application apparatus and an application method, which are capable of being realizing with relatively low cost and forming a coating film with a uniform thickness.

According to the invention for solving the above problem, there is a slit coating type application apparatus including: a holding table which holds a substrate on a vertically lower surface; a first liquid tank which is disposed so as to face the surface of the substrate held on the holding table and stores a predetermined coating liquid; a coating head which is held so as to be vertically moved in the first liquid tank and has a slit-shaped nozzle for flowing the coating liquid stored in the first liquid tank toward the surface of the substrate; a second liquid tank which is supported so as to be vertically moved, communicates with the first liquid tank through a communicating pipe, and stores the coating liquid; and a height control unit which controls the height of the second liquid tank according to the movement of the coating head when the coating liquid is coated on the substrate.

In the slit coating type application apparatus according to the invention, a pressure variation in the first liquid tank according to the movement of the coating head can be suppressed by controlling the height of the second liquid tank according to the movement of the coating head. That is, by controlling the height of the second liquid tank so as to flow the coating liquid from the first liquid tank or flow the coating liquid into the first liquid tank, the pressure variation in the first liquid tank is suppressed. Accordingly, a variation in outflow amount of the coating liquid from the nozzle is prevented and the coating film can be formed on the surface of the substrate with a uniform thickness.

The height control unit may further control the height of the second liquid tank according to the height of the liquid level of the coating liquid in the first liquid tank. Accordingly, it is possible to further suppress the pressure variation in the first liquid tank with certainty. For example, although the pressure variation occurs by the decrease of coating liquid in the first liquid tank according to the coating of the coating liquid on the substrate, the second liquid tank moves upward according to the decrease of coating liquid in the first liquid tank such that the coating liquid flows from the second liquid tank into the first liquid tank and a predetermined amount of coating liquid is secured in the first liquid tank. Accordingly, the pressure variation in the first liquid tank is suppressed.

The communicating pipe may have a thickness of a degree not to hinder the flow of the coating liquid in the communicating pipe due to the influence of the viscosity of the coating liquid. Accordingly, the flow of the coating liquid is smoothly performed and thus the pressure variation in the first liquid tank is suppressed with certainty.

The second liquid tank may be arranged such that vibration according to the movement of the second liquid tank does not propagate to the first liquid tank. Accordingly, the pressure variation in the first liquid tank due to the vibration applied to the first liquid tank can be prevented.

In addition, according to the present invention, there is provided an application method using a slit coating type application apparatus including a holding table which holds a substrate on a vertically lower surface, a first liquid tank which is disposed so as to face the surface of the substrate held on the holding table and stores a predetermined coating liquid, a coating head which is held so as to be vertically moved in the first liquid tank and has a slit-shaped nozzle for flowing the coating liquid stored in the first liquid tank toward the surface of the substrate, and a second liquid tank which is supported so as to be vertically moved, communicates with the first liquid tank through a communicating pipe, and stores the coating liquid, wherein the outflow amount of coating liquid from the nozzle is adjusted by controlling the height of the second liquid tank according to the movement of the coating head when the coating liquid is coated on the substrate.

In the application method according to the invention, a pressure variation in the first liquid tank according to the movement of the coating head can be suppressed by controlling the height of the second liquid tank according to the movement of the coating head. Thus, the outflow amount of coating liquid from the nozzle is adjusted to be substantially uniformed. Accordingly, the coating film can be formed on the surface of the substrate with a uniform thickness.

In addition, according to the present invention, there is provided a method of manufacturing a coated material using a slit coating type application apparatus including a holding table which holds a substrate on a vertically lower surface, a first liquid tank which is disposed so as to face the surface of the substrate held on the holding table and stores a predetermined coating liquid, a coating head which is held so as to be vertically moved in the first liquid tank and has a slit-shaped nozzle for flowing the coating liquid stored in the first liquid tank toward the surface of the substrate, and a second liquid tank which is supported so as to be vertically moved, communicates with the first liquid tank through a communicating pipe, and stores the coating liquid, wherein the coating liquid flowing from the nozzle is coated on the substrate while the outflow amount of coating liquid from the nozzle is adjusted by controlling the height of the second liquid tank according to the movement of the coating head.

In the method of manufacturing the coated material according to the invention, it is possible to manufacture the coated material on which the coating film with the uniform thickness is formed on the surface of the substrate.

### BRIEF DESCRIPTION OF THE DRAWINGS

FIG. 1 is a perspective view showing the schematic configuration of a slit coating type application apparatus according to an embodiment of the invention.

FIG. 2 is a cross-sectional view showing the schematic configuration of the slit coating type application apparatus according to the embodiment of the invention.

FIG. 3 is a schematic view showing an application method according to an embodiment of the invention.

FIG. 4 is a schematic view showing the application method according to the embodiment of the invention.

1: substrate, 2: coating liquid, 3: coating film, 10: slit coating type application apparatus, 20: holding table, 30: first liquid tank, 40: coating head, 41: nozzle, 50: second liquid tank, 60: communicating pipe

### DESCRIPTION OF PREFERRED EMBODIMENTS

Hereinafter, the embodiments of the invention will be described in detail.

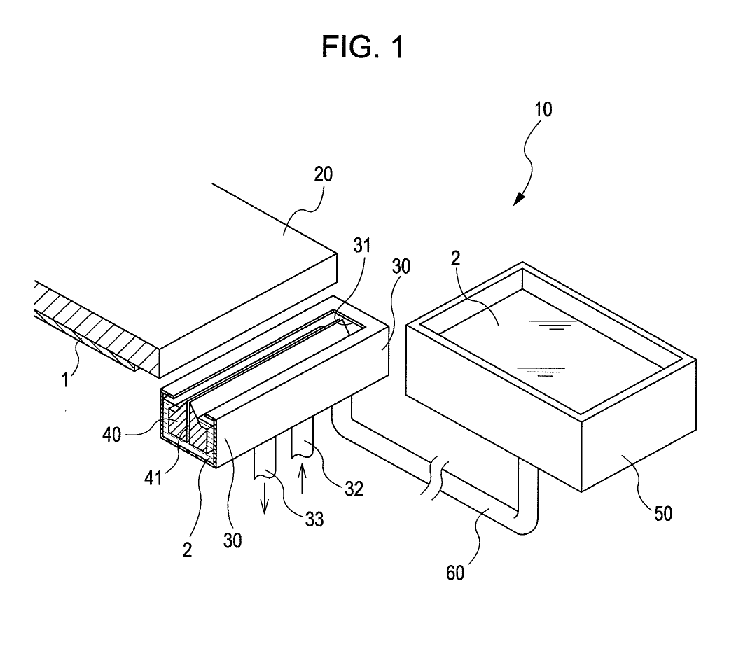

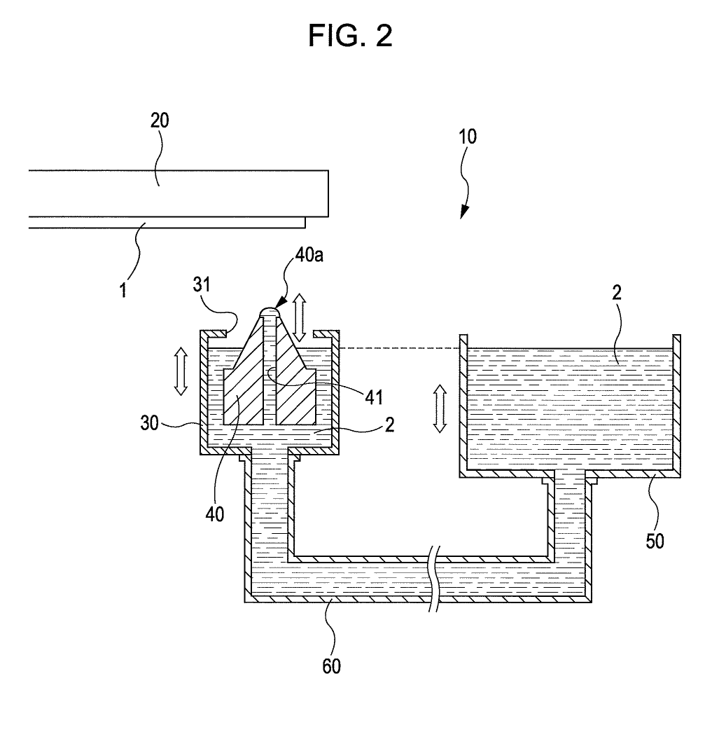

FIG. 1 is a perspective view showing the schematic configuration of a slit coating type application apparatus according to an embodiment of the invention. FIG. 2 is a cross-sectional view showing the schematic configuration of the slit coating type application apparatus. As shown, the slit coating application apparatus 10 according to the present embodiment includes, for example, a holding table 20 on which a substrate 1 such as a silicon wafer, a semiconductor substrate or the like is held, a first liquid tank 30 which is provided at the side of the substrate 1 of the holding table 20 and stores a coating liquid 2, a coating head 40 disposed in this first liquid tank 30, and a second liquid tank 50 which stores the coating liquid 2 similar to the first liquid tank 30. The holding table 20, the first liquid tank 30 in which the coating head 40 is disposed, and the second liquid tank 50 are disposed in a main body of a sealed device (not shown).

The holding table 20 holds the substrate 1 on a vertically lower surface such that the surface of the substrate faces vertically downward. A method of holding the substrate 1 by the holding table 20 is not specially limited, but, for example, a method using suction of a vacuum pump or the like may be used. In addition, the holding table 20 is, for example, provided so as to be moved by a table driving unit such as a driving motor (not shown) or the like in an in-plane direction of the substrate 1.

The first liquid tank 30 has a volume suitable for storing a predetermined amount of coating liquid 2 in a state in which the coating head 40 is disposed therein, and an opening 31 for exposing the front end of the coating head 40 is provided in the upper surface thereof. Although not shown, the first liquid tank 30 is supported so as to be vertically moved by a supporting mechanism.

In addition, a supply pipe 32 for supplying the coating liquid 2 into the first liquid tank 30 and a discharge pipe 33 for discharging the coating liquid 2 are connected to the first liquid tank 30. Although not shown, a storage tank for storing the coating liquid 2 through a liquid transmission unit such as a pump or the like is connected to the supply pipe 32, and the coating liquid is resupplied from the storage tank at a predetermined timing. Meanwhile, although not shown, an opening/closing unit such as a value or the like is provided in the discharge pipe 33, and, if necessary, this opening/closing unit is opened such that the coating liquid 2 in the first liquid tank 30 is discharged from the discharge pipe 33 to the outside thereof.

A slit-shaped nozzle 41 penetrating through the coating head in a thickness direction is provided in the coating head 40 and this nozzle 41 is supported in the first liquid tank so as to be vertically opened upwards. The coating liquid 2 in the first liquid tank 30 flows from the lower end side of the coating head 40 into the nozzle 41 by a capillary phenomenon, and a predetermined amount of coating liquid 2 protrudes from the front end surface 40a (the opening of the upper end side of the nozzle 41) of the coating head 40 by the internal pressure of the first liquid tank 30. This coating head 40 is supported in the first liquid tank 30 so as to be vertically moved, although not shown. That is, the coating head 40 is provided so as to be moved by the movement of the first liquid tank 30 and to be vertically moved independent of the first liquid tank 30.

Such a coating head 40 is properly moved, for example, in consideration of the kinetic viscosity of the coating liquid 2, wettability of the substrate 1 with the coating liquid 2, the thickness of the coating liquid 2 (the thickness of the coating film) coated on the substrate 1, and so on, and, as described below, the gap between the front end of the coating head 40 and the surface of the substrate 1 is adjusted, such that the coating film with the uniform thickness is formed on the surface of the substrate 1.

The second liquid tank 50 stores the coating liquid 2 similar to the first liquid tank 30 and is connected to the first liquid tank 30 through the communicating pipe 60. That is, the coating liquid 2 can be always moved between the first liquid tank 30 and the second liquid tank 50 through the communicating pipe 60. Accordingly, the liquid level of the coating liquid 2 in the first liquid tank 30 and the liquid level of the coating liquid in the second liquid tank 50 basically have the same height.

Although described in detail later, in the slit coating type application apparatus 10 of the invention, the height of the second liquid tank 50, that is, the height of the coating surface of the coating liquid 2 in the second liquid tank 50, is properly controlled by the movement of the coating head 40 (height control unit). That is, the height of the second liquid tank 50 is controlled so as to suppress a pressure variation in the first liquid tank 30 due to the movement of the second liquid tank 50, such that the amount of coating liquid 2 flowing from the nozzle 41 of the coating head 40 is properly adjusted.

Accordingly, it is preferable that the volume of the second liquid tank 50 is relatively large and is larger than at least that of the first liquid tank. Accordingly, the pressure variation in the first liquid tank 30 due to the movement of the second liquid tank 50 can be relatively easily suppressed.

The pressure variation in the first liquid tank 30 may occur by vibration. Accordingly, it is preferable that the second liquid tank 50 is arranged, for example, at a position separated as far as possible from the first liquid tank 30 such that vibration due to the movement of the second liquid tank 50 does not propagate to the first liquid tank 30.

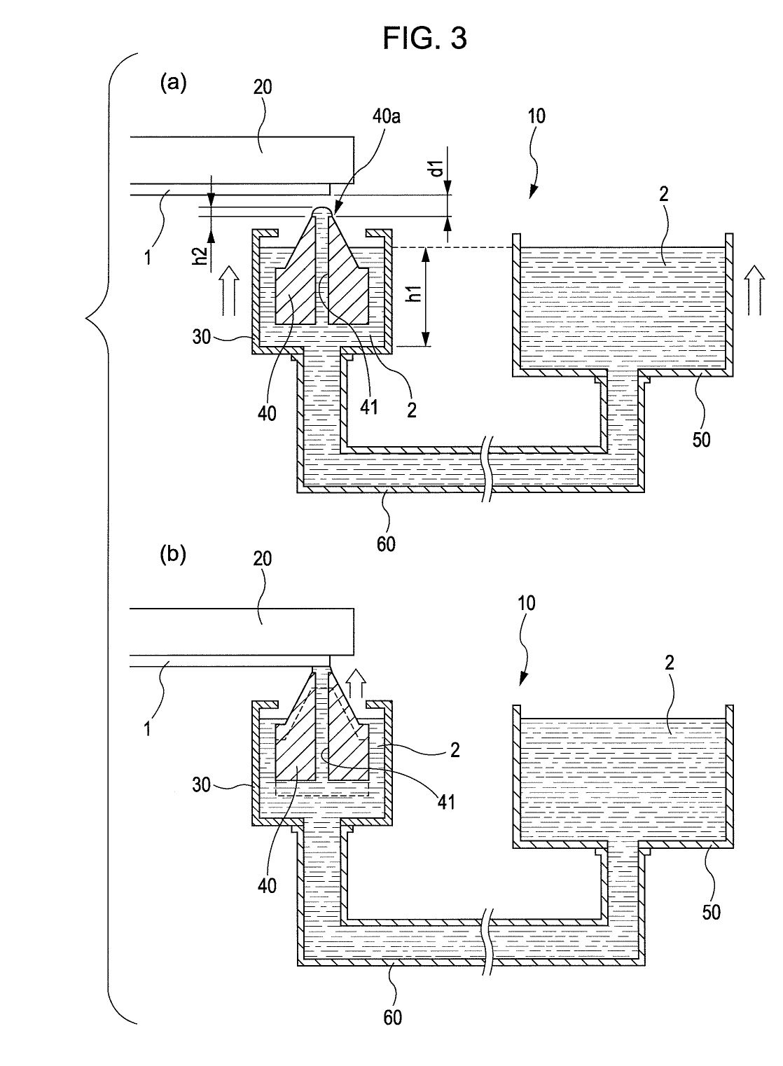

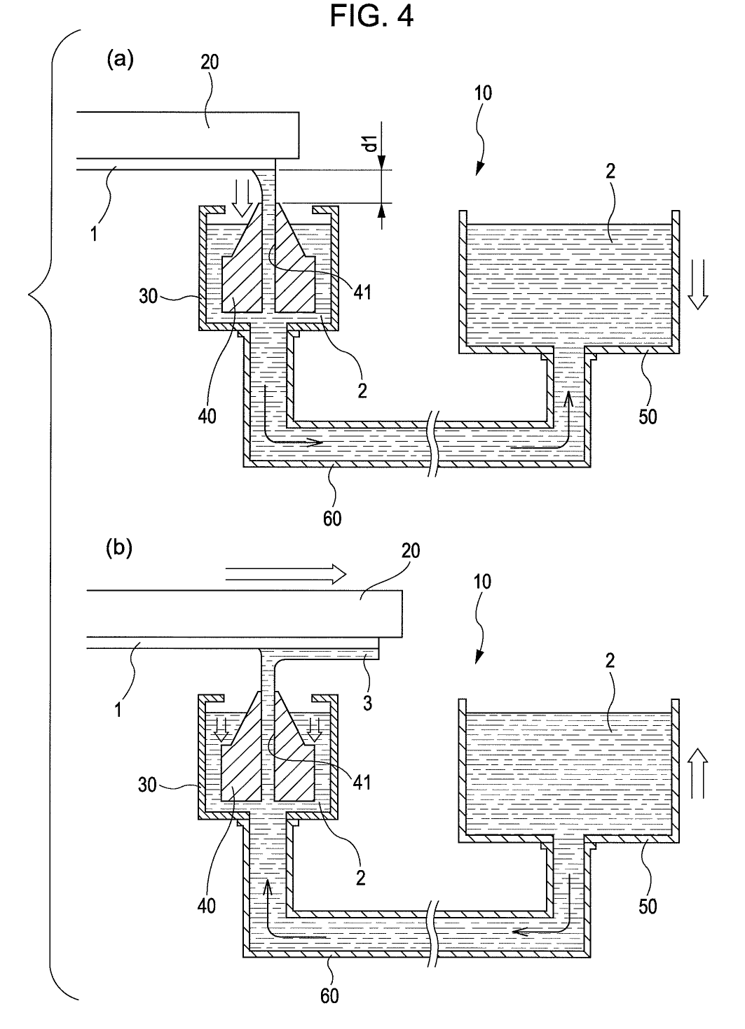

Hereinafter, an application method using such a slit coating type application apparatus will be described. FIGS. 3 and 4 are schematic views showing the operation of the slit coating type application apparatus.

First, as shown in FIG. 3(a), the substrate 1 is fixed to the lower surface of the holding table 20, and the first liquid tank 50 moves upward such that the gap d1 between the front end surface 40a of the coating head 40 and the surface of the substrate 1 becomes a predetermined gap. At this time, the coating head 40 is fixed to the first liquid tank 30, and the height of the coating head 40 relative to the first liquid tank 30 is adjusted such that the predetermined amount of coating liquid 2 protrudes from the front end surface 40a.

The second liquid tank 50 moves upward simultaneously with the first liquid tank 30. That is, the first and second liquid tanks 30 and 50 move upward in a state in which the height of the liquid level of the coating liquid 2 in the first liquid tank 30 and the liquid level of the coating liquid 2 in the second liquid tank 50 are identical, without changing the liquid level height h1 of the coating liquid 2 in the first liquid tank 30. Accordingly, the height h2 of the coating liquid protruding from the front end surface 40a of the coating head 40 is constantly held.

Although, in the present embodiment, the gap between the front end surface 40a of the coating head 40 and the surface of the substrate 1 is adjusted by vertically moving the first liquid tank 30 upward, the holding table 20 may vertically move downward in a state in which the first liquid tank 30 is fixed.

Next, in a state in which the coating liquid 2 protrudes from the front end surface 40a of the coating head 40, as shown in FIG. 3(b), only the coating head 40 moves upward such that the coating liquid 2 is brought into contact with the surface of the substrate 1. Since the liquid level height h2 of the coating liquid 2 may be slightly decreased by the upward movement of the coating head 40, it is preferable that the coating head 40 moves upward until the gap d1 between the front end surface 40a of the coating head 40 and the surface of the substrate 1 becomes a gap of a half of the liquid level height h2 of the coating liquid 2.

For example, if the liquid level height h2 of the coating liquid 2 protruding from the front end surface 40a of the coating head 40 is about 20 μm (FIG. 3(a)), it is preferable that the coating head 40 moves upward such that the gap d1 between the front end surface 40a of the coating head 40 and the surface of the substrate 1 becomes about 10 μm. Accordingly, it is possible to bring the coating solution 2 into contact with the surface of the substrate 1 with certainty.

Next, as shown in FIG. 4(a), the coating head 40 moves downwards and the gap d1 between the front end surface 40a of the coating head 40 and the surface of the substrate 1 is adjusted. That is, the gap d1 between the coating head 40 and the surface of the substrate 1 is adjusted according to the thickness of the coating film formed on the surface of the substrate 1. For example, if the coating film having a thickness of 160000 angstroms is formed, the coating head 40 moves downward and the gap between the front end surface 40a of the coating head 40 and the surface of the substrate 1 becomes about 180 μm.

Next, in a state in which the gap d1 is adjusted, as shown in FIG. 4(b), the holding table 20 is linearly moved in the plane direction (horizontal direction) of the substrate 1 such that the coating of the coating liquid 2 onto the surface of the substrate 1 is started. That is, the formation of the coating film 3 on the surface of the substrate 1 is started. In addition, by the movement of the holding table 20, the coating liquid 2 continuously flows from the nozzle 41 of the coating head 40 and the coating film 3 is formed on the entire surface of the substrate 1. Thereafter, if necessary, the coating film 3 is cured and the coated material in which the coating film 3 is formed on the entire surface of the substrate 1 is obtained.

When the coating head 40 moves downward as described above (FIG. 4(a)), the coating head 40 is immersed in the coating liquid 2 of the first liquid tank 30 such that a pressure variation occurs in the first liquid tank 30. That is, the internal pressure of the first liquid tank 30 is increased and the amount of coating liquid 2 flowing into the nozzle 41 of the coating head 40 is increased.

Accordingly, after the coating head 40 moves downward as described above, when the holding table 20 is moved and the coating of the coating liquid 2 is started (FIG. 4(b)), the thickness of the coating film 3 formed on the surface of the substrate 1 may be partially increased. The variation in film thickness is changed according to a condition such as the viscosity of the coating liquid 2 or the like, but is generated after a while from the starting of the coating.

In order to prevent the variation in film thickness of the coating film 3, in the invention, when the coating head 40 moves downward (FIG. 4(a)), the second liquid tank 50 moves downward simultaneously with the downward movement of the coating head 40 such that the increase in the pressure in the first liquid tank 30 (the liquid level height of the coating liquid 2 in the first liquid tank 30) is prevented. Accordingly, it is possible to prevent the coating liquid 2 flowing into the nozzle 41 of the coating head 40 from being increased. That is, it is possible to prevent the coating liquid 2 flowing from the front end surface 40a of the coating head 40 from being increased. Accordingly, it is possible to form the coating film 3 on the surface of the substrate 1 with the uniform film thickness.

By providing the second liquid tank 50 and properly controlling the height of the second liquid tank 50, the application apparatus for uniformizing the film thickness of the coating film 3 can be realized with relatively low cost, compared with, for example, the case where a sack back valve or the like is provided.

Although, in the present embodiment, the height of the second liquid tank 50 is controlled by the movement of the coating head 40, it may be additionally controlled according to the liquid level height h1 of the coating liquid 2 in the first liquid tank 30.

For example, as the coating film 3 is formed on the surface of the substrate 1, the amount of coating liquid 2 stored in the first liquid tank 30 is decreased. However, in the slit coating type application apparatus 10 of the invention, since the coating liquid 2 is resupplied from the second liquid tank 50 to the first liquid tank 30 according to the decrease of the coating liquid 2 in the first liquid tank 30, the decrease amount of the liquid is not large. However, even the coating liquid 2 is resupplied from the second liquid tank 50, the coating liquid 2 in the first liquid tank 30 is gradually decreased and the internal pressure of the first liquid tank 30 is also gradually decreased. At this time, in addition to the kinetic viscosity of the coating liquid 2 and the wettability of the substrate 1 with the coating liquid 2, the amount of coating liquid 2 flowing from the nozzle 41 of the coating head 40 is gradually decreased by the decrease in internal pressure of the first liquid tank 30.

Accordingly, the height of the second liquid tank may be further controlled according to the amount (liquid level height h1) of the coating liquid 2 in the first liquid tank 30. In detail, after the holding table 20 is moved and the coating of the coating liquid 2 is started, as denoted by an arrow of FIG. 4(b), the second liquid tank 50 may move upward by the decrease in amount (liquid level height) of the coating liquid 2 in the first liquid tank 30. Accordingly, the coating liquid 2 flows from the second liquid tank 50 into the first liquid tank 30 such that the decrease in liquid level height of the coating liquid 2 in the first liquid tank 30 is suppressed. Thus, a substantial constant amount of coating liquid 2 always flows from the nozzle of the coating head 40. Accordingly, the coating film 3 with the uniform film thickness can be formed well on the surface of the substrate 1.

Although the embodiment of the invention is described, the invention is not limited to this embodiment and may be variously modified without departing from the scope of the invention.

1. A slit coating type application apparatus comprising:
a holding table which holds a substrate on a vertically lower surface;
a first liquid tank which is disposed so as to face the surface of the substrate held on the holding table and stores a predetermined coating liquid;
a coating head which is held so as to be vertically moved in the first liquid tank and has a slit-shaped nozzle for flowing the coating liquid stored in the first liquid tank toward the surface of the substrate;
a second liquid tank which is supported so as to be vertically moved, communicates with the first liquid tank through a communicating pipe, and stores the coating liquid; and
a height control unit which controls the height of the second liquid tank according to the movement of the coating head when the coating liquid is coated on the substrate.

2. The slit coating type application apparatus according to claim 1, wherein the height control unit further controls the height of the second liquid tank according to the height of the liquid level of the coating liquid in the first liquid tank.

3. The slit coating type application apparatus according to claim 1, wherein the communicating pipe has a thickness of a degree not to hinder the flow of the coating liquid in the communicating pipe due to the influence of the viscosity of the coating liquid.

4. The slit coating type application apparatus according to claim 1, wherein the second liquid tank is arranged such that vibration according to the movement of the second liquid tank does not propagate to the first liquid tank.

5. An application method using a slit coating type application apparatus including a holding table which holds a substrate on a vertically lower surface, a first liquid tank which is disposed so as to face the surface of the substrate held on the holding table and stores a predetermined coating liquid, a coating head which is held so as to be vertically moved in the first liquid tank and has a slit-shaped nozzle for flowing the coating liquid stored in the first liquid tank toward the surface of the substrate, and a second liquid tank which is supported so as to be vertically moved, communicates with the first liquid tank through a communicating pipe, and stores the coating liquid,
wherein the outflow amount of coating liquid from the nozzle is adjusted by controlling the height of the second liquid tank according to the movement of the coating head when the coating liquid is coated on the substrate.

6. A method of manufacturing a coated material using a slit coating type application apparatus including a holding table which holds a substrate on a vertically lower surface, a first liquid tank which is disposed so as to face the surface of the substrate held on the holding table and stores a predetermined coating liquid, a coating head which is held so as to be vertically moved in the first liquid tank and has a slit-shaped nozzle for flowing the coating liquid stored in the first liquid tank toward the surface of the substrate, and a second liquid tank which is supported so as to be vertically moved, communicates with the first liquid tank through a communicating pipe, and stores the coating liquid,
wherein the coating liquid flowing from the nozzle is coated on the substrate while the outflow amount of coating liquid from the nozzle is adjusted by controlling the height of the second liquid tank according to the movement of the coating head.
